(19) United States
(12) Patent Application Publication
(10) Pub. No.: US 2023/0281728 A1
(43) Pub. Date: Sep. 7, 2023

(54) Social Media Content Filtering For Emergency Management

(71) Applicant: The Regents of the University of Colorado, a body corporate, Denver, CO (US)

(72) Inventor: Lise A. St. Denis, Denver, CO (US)

(21) Appl. No.: 18/000,314

(22) PCT Filed: Jun. 1, 2021
(86) PCT No.: PCT/US2021/035218

§ 371 Date: Nov. 30, 2022

Related U.S. Application Data
(60) Provisional application No. 63/033,167, filed on Jun. 1, 2020.

(51) Int. Cl. G06Q 50/00; G06Q 50/26; G06F 18/2415

(52) U.S. Cl. CPC G06Q 50/01; G06F 18/2415; G06Q 50/265

(57) ABSTRACT

Various embodiments of the present disclosure relate to a multimodal data classifier, and a method of training the classifier therein, that identifies social network messages about an event and filters the messages to provide a reduced amount of content to assist emergency authorities. For each message identified, the classification model identifies features of the message including an account identity and content of the message. Further, it generates a feature embedding for the message based at least on the account identity and the content of the message, and it submits the feature embeddings as input to a machine learning model to obtain one or more classifications for the message. As a result, the data classifier filters the messages based on the one or more classifications, which provides a prioritized view of the messages based on training criteria.

### RELATED APPLICATIONS

This application hereby claims the benefit and priority to U.S. Provisional Application No. 63/033,167, titled “FRAMEWORK FOR SOCIAL MEDIA MONITORING,” filed Jun. 1, 2020, which is hereby incorporated by reference in its entirety.

### TECHNICAL FIELD

Various embodiments of the present technology relate to data classification using machine learning models and systems, methods, and devices for classifying social network messages related to an emergency event.

### BACKGROUND

Machine learning applications can help analyze data, organize content, and filter out noise, or otherwise already known or extraneous information, to help identify important information at reduced amounts. To apply machine learning algorithms, vast amounts of data and human-classified outputs of the data set must be put in place to allow the algorithms to function with less manual input. Classifications resulting from a machine learning algorithm tend to identify data with a narrow focus, meaning as the desired output changes, models may have to be re-trained with extensive effort.

With the continued rise in social media networks, users can provide invaluable information during a disaster or crisis; however, sorting through redundant, redistributed, and/or unhelpful information can raise challenges. Emergency management personnel have begun using machine learning and neural network applications to help responders quickly identify mission-critical information. Some efforts focus on user-classification while others cluster or label individual social media posts to manage the deluge of information. Specifically, such techniques offer classification schemes focusing on identification of sources, credibility of user/information, location with respect to event, and emotional content assessment.

Although current models and approaches to analyzing disaster-related data from social media networks exist, they fall short and pose various issues for emergency managers, such as real-time filtering ability, re-training efforts, and lack of generalization. User and content classifiers are trained for event-specific purposes with a narrow scope in locations, organizations, and occurrences. Thus, when a new event or disaster takes place, classifiers must be re-trained or created from scratch with another specific training data set. The time and effort to re-train data sets can allow information to slip through the cracks, especially during the early hours of a catastrophe. Further, existing classifiers still depend on valuable human annotation time at the onset of a new disaster and throughout the time period the model is functioning. An example approach is a decision-level fusion function, which uses neural network layers to learn feature vectors through a single loss function. This approach fails to learn across pre-processed data and low-level features of different modalities, because fixed predictions are learned by optimizing independent loss functions.

### OVERVIEW

A multimodal data classifier is disclosed herein that identifies social network messages about an event and filters the messages to provide reduced amounts of content to assist emergency authorities. The data classifier identifies features of the messages to determine what type of account produced the message and whether the content includes first-hand, personalized information. Filtering of social network data provides at least one or more benefits such as reliability of information, preciseness of targeted searches, and efficiency in classifying such data.

In an embodiment, a method of operating a data classification model comprises identifying messages on a social network associated with an event. The messages may include text about the event, support or community outreach related to the event, images of the event, and the like. For each message, the classification model identifies features of the message including an account identity and embedded/linked content of the message. It generates a feature embedding for the message based at least on the account identity and the content of the message. And it submits the feature embeddings as input to a machine learning model to obtain one or more classifications for the message. As a result, the data classifier filters the messages based on the one or more classifications, which provides a prioritized view of the messages based on training criteria. It may be appreciated that other representations of the disclosed technology herein can include further systems, computing apparatuses, and methods of training a data classification model.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 illustrates an exemplary operating architecture that demonstrates a data classification system in an implementation.

FIG. 2 illustrates an example set of operations by which data classification may be accomplished in an implementation.

FIG. 3 illustrates a method by which a machine learning model can be trained in an implementation.

FIG. 4 illustrates an exemplary operating environment in which a data classifier can be utilized in an implementation.

FIG. 5 illustrates an exemplary operating environment in which a data classifier can be utilized in an implementation.

FIG. 6 illustrates an example of delivering classification results to an end-user in an implementation.

FIG. 7 illustrates exemplary model results following data classification in an implementation.

FIG. 8 illustrates exemplary model results following data classification in an implementation.

FIG. 9 illustrates a computing system suitable for implementing the various operational environments, modules, architectures, processes, scenarios, and sequences discussed herein with respect to the Figures.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology relate to data classification using multimodal deep learning models and systems, methods, and devices for classifying social network messages related to an emergency event. In operation, a data classifier identifies messages on a social media network associated with an event, such as a natural disaster or other catastrophe. The classifier can obtain data from the account associated with each message, including visual information, statistical information, and the like. For each identified message, the classifier identifies features of the message. Features can pertain to the account identity or name, the content of the message, a timestamp of the message, and/or a location of the message, as examples. Using the account identity and other features of the message, the classifier generates a feature embedding for the message for use in one or more neural network layers. The classifier submits each feature embedding created into a machine learning model to obtain one or more classifications for the message and/or account. Resulting classifications can categorize accounts into a type (i.e., organization, personal, feed-based) and/or a role (i.e., emergency management, public sector, media, redistribution, personalized), and it can filter and predict type of content and level of interest in specific messages based on the type of content being shared (i.e., social media platforms, official messaging, news outlet). The classifier algorithm can then filter or prioritize the messages based on the one or more classifications.

The machine learning models can include deep learning applications and layers used for different types of data, each of which can be trained to perform the classification process. For example, visual data can be analyzed using a convolution neural network, textual information can be input into a long short-term memory layer, and numerical features can be entered into a dense or fully-connected layer. Each layer can submit its output to a concatenation layer where learnable weights can combine and compare the data for classification. It may be appreciated that other neural networks, layers, or combinations thereof can be utilized by the data classification model to filter social media posts for emergency management use.

In another embodiment, a computer apparatus is provided. The computing apparatus comprises one or more computer readable storage media and program instructions stored on the one or more computer readable storage media that, when read and executed by one or more processors, direct the computing apparatus to perform functions. For example, the program instructions can direct the computing apparatus to identify messages on a social network associated with an event. For each message identified, the program instructions can direct the computing apparatus to identify features of the message including an account identity and content of the message, source type for shared content, generate feature embeddings for the messages based at least on the account identity and the content of the messages, and submit the feature embeddings as input to a machine learning model to obtain one or more classifications for the message. Ultimately, the program instructions can direct the computing apparatus to filter the messages based on the one or more classifications.

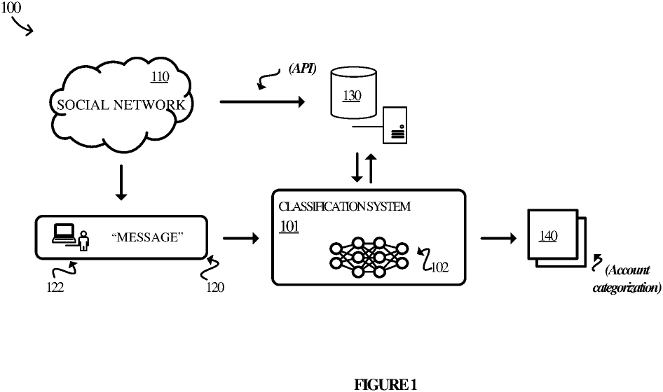

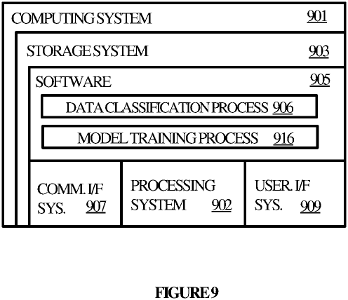

Turning to the Figures, FIG. 1 illustrates an exemplary operating architecture 100 demonstrating a data classification system in an implementation. Operating architecture 100 includes classification system 101, social network 110, social network microblogs 120, social network accounts 122, a database 130, and a classification output 140. Classification system 101 includes a trained multimodal model 102 that provides data classification capabilities using the inputted information. Data classification environment 100 may be implemented in hardware, software, and/or firmware, and in the context of one or more computing systems, of which computing system 901 in FIG. 9 is representative.

Social network 110 stores user accounts 122 and microblogs 120 associated with user accounts 122. In operation, classification system 101 selects a topic or keyword to begin a query of social network 110 via database 130 to retrieve microblogs 120 and user accounts 122 associated with the microblogs related to the topic or keyword search. Database 130 can obtain the user accounts 122 and microblogs 120 via an application programming interface (API), or some other communication link to social network 110. Using the collected data related to the search query, classification system 101 calculates statistical information about the microblogs 120 and the user accounts 122. This entails determining visual, textual, and numeric data about the data set. Then, classification system 101 communicates with database 130 to store all relevant information on the topic. Database 130 can store the information in a local network, a remote cloud location, or some other computer-readable storage media for further access.

Visual, textual, and numeric data related to the user accounts 122 and microblogs 120 allow classification system 101 to determine at least an account role, account type, and a message type. For example, visual information about user accounts 122 can include information such as a profile picture or image that is embedded in microblog 120. Textual information can include biography information on user account 122, content of microblogs 120, and the like. Specifically, content of microblogs 120 can refer to the message itself and/or any embedded sources or links provided and the content of the source location. Numeric features can include number of microblogs 120 per user account 122, length of microblog 120, time between microblogs 120, active time on social network 110, and more. Classification system 101 can use each of these as inputs to multimodal model 102.

Once classification system 101 obtains any topic-relevant microblogs 120, associated user accounts 122, associated statistics with both user accounts 122 and microblogs 120, it can instruct multimodal model 102 to generate feature embeddings based on the features and statistics. Multimodal model 102 then takes each feature embedding and concatenates them to arrive at a classification output 140.

Classification output 140 classifies user accounts 122 into specific account type and account role categories and microblogs 120 into a message type. These categories comprise several classifications that help identify relevant accounts and messages as they pertain to an event, such as a natural disaster, accident, and/or national or local crisis. In various implementations, user accounts 122 can be classified as a personal account of a person, a news/media outlet account, an emergency responder account, and the like. Microblogs 120, or messages from a social network feed, news articles, or other messages posted or sent to a person, can be classified as reactions, sourced news, information sharing, information seeking, general commentary, and more.

By way of example, an emergency response team can filter the classified output 140 to find social network accounts that generate personalized information relevant to the response team to help mitigate the crisis or event, such as a wildfire in a county. While the social network 110 may have hundreds or thousands of microblogs 120 related to the wildfire event, classification system 101 can use the identified microblogs 120 as inputs to multimodal model 102 to filter specific results. In various embodiments, classification output 140 can weigh a priority level of the messages to display the highest priority messages on a user interface to an end-user, such as the emergency response team to the wildfire. It may be appreciated that classification output 140 can be communicated or displayed to a user via a social network, a smart phone, tablet, computer, or other graphical user interface, among others.

It may be appreciated by one skilled in the art that filtering the output can occur in various ways, including using multiple layers, mass filtering, and filtering using only chosen subsets. For example, in the context of the disclosed data classifier, a primary filter can first filter a data set by an account type and/or message type. A secondary filter can subsequently filter the data set by specific content of the message, such as content of an embedded source.

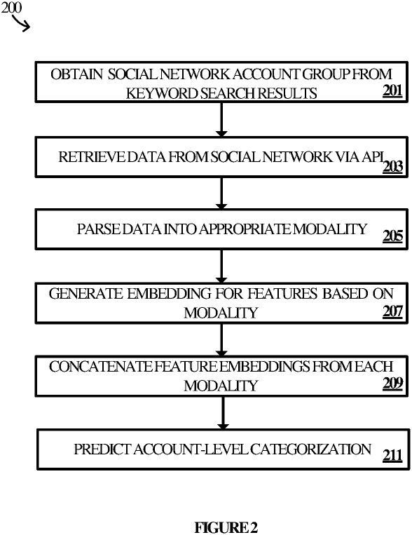

FIG. 2 illustrates an example method by which data classification may be accomplished in an implementation. To achieve the data classification results discussed herein, one or more computing systems that provide operating architecture 100 of FIG. 1 execute data classification process 200 in the context of the components of operating architecture 100. Data classification process 200, illustrated in FIG. 2, may be implemented in program instructions in the context of any of the hardware, software applications, modules, or other such programming elements that comprise classification system 101 and database 130. The program instructions direct their host computing system(s) to operate as described for data classification process 200, referring parenthetically to the steps in FIG. 2.

In operation, data classification process 200 begins after a keyword or topic search returns results within the social network with a group of social network microblogs and associated accounts. The database queries the social network for data related to the keyword and obtains (201) messages or microblogs associated with the event along with account information, visual and numeric statistics associated with the microblog and account(s), and the content of the messages including any embedded links or sources. The data pertaining to the keyword topic/event, can be retrieved (203) from the social network via an API, or some other communication protocol.

After a classification system gathers message and account information, the model parses (205) each type of data into its appropriate modality. Modalities may include visual, textual, and numeric modalities. Accordingly, the microblog’s text or content functions as an input to the textual modal. Content of the microblog may include the message of the microblog, a link embedded or hyperlinked in the microblog, and/or content of the source of the link itself. The picture associated with the account functions as an input to the visual modal. And, likewise, the statistics associated with the microblog and account function as an input to the numeric modal, for example.

In one implementation, statistical data that parses into the numeric modal may be derived from the account user’s behavior on the social network, keyword indicators, and/or latent Dirichlet allocation (LDA). The model may also make other calculations, such as temporal entropy to assess levels of irregularity in user activity patterns.

Next, upon the model intaking data from the database and parsing the data into appropriate modalities, the model generates (207) embeddings for features based on the modality. For example, one or more modalities may convert unigrams into topic score vectors to score each microblog or weigh a statistic of an individual account.

After the model creates a feature embedding representative of each feature, the model concatenates (209) each feature embedding along with any hidden layer activations from each modality. The model may have a fully connected layer after the concatenation stage that allows the model to obtain a final output vector. In various implementation, the model uses this output vector to make a classification prediction (211) at the social network account-level. As mentioned above, this classification may denote a particular account type and role for each individual account input from the social network. Alternatively, the model can make a classification at the message-level to denote a particular message type and a priority level or rating of the message (i.e., high priority, medium priority, low priority). The more on-topic, relevant, and individualized the message, for example, the higher importance or priority the classifier can weigh the message.

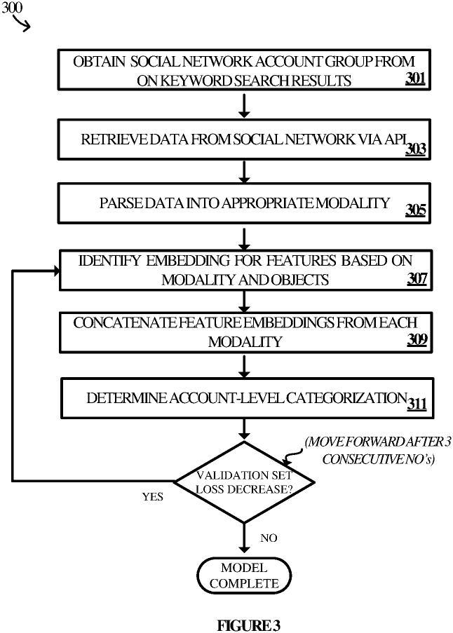

FIG. 3 illustrates a method by which a machine learning model can be trained in an implementation. In order for the model to achieve the data classification prediction results discussed above, the one or more computing systems that provide operating architecture 100 of FIG. 1 execute process 300 in the context of the components of operating architecture 100. Process 300, illustrated in FIG. 3, may be implemented in program instructions in the context of any of the hardware, software applications, modules, or other such programming elements that comprise classification system 101 and database 130. The program instructions direct their host computing system(s) to operate as described for process 200, referring parenthetically to the steps in FIG. 3.

The model, such as the model used in process 200 of FIG. 2, can be trained using various steps tested over several iterations. In operation, model training process 300 begins by inputting a keyword or topic search and obtaining (301) results within the social network with a group of social network microblogs and associated accounts. A database queries the social network for data related to the keyword and obtains (201) messages or microblogs associated with the event along with account information and visual and numeric statistics associated with the microblog and account(s). The data pertaining to the keyword topic/event, can be retrieved (303) from the social network via an API, or some other communication protocol.

After the model gathers message and account information, the model parses (305) each type of data into its appropriate modality. Modalities may include visual, textual, and numeric modalities. Accordingly, the microblog’s content functions as an input to the textual modal. Content of the microblog may include the message of the microblog, a link embedded or hyperlinked in the microblog, and/or content of the source of the link itself. The picture associated with the account functions as an input to the visual modal. And, likewise, the statistics associated with the microblog and account function as an input to the numeric modal, for example.

Next, upon the model intaking data from the database and parsing the data into appropriate modalities, the model identifies (307) embeddings for features based on the modality. For example, one or more modalities may convert unigrams into topic score vectors to score each microblog or weigh a statistic of an individual account. The model can begin to recognize textual features of the inputs, associate like pictures, and identify patterns between the data based at least on the feature embeddings.

After the model creates a feature embedding representative of each feature, the model concatenates (309) each feature embedding along with any hidden layer activations from each modality. The model may have a fully connected layer after the concatenation stage that allows the model to obtain a final output vector. In various implementations, the model uses this output vector to determine (311) an account-level categorization at the social network account-level. As mentioned above, this classification may denote a particular account type and role for each individual account input from the social network. Alternatively, for a prioritized subset of account messages, the model can make a classification at the message-level to denote a particular message content source type and a priority level or rating of the message (i.e., high priority, medium priority, low priority). The more on-topic, relevant, and personalized the message, for example, the higher importance or priority the classifier can weigh the message.

In model training process 300, upon determination of a classification of the social network account, the training model identifies any set loss. The model can continue to refine feature embeddings across each modality and concatenate them, repeating training process 300, until the validation set loss does not decrease for three consecutive iterations.

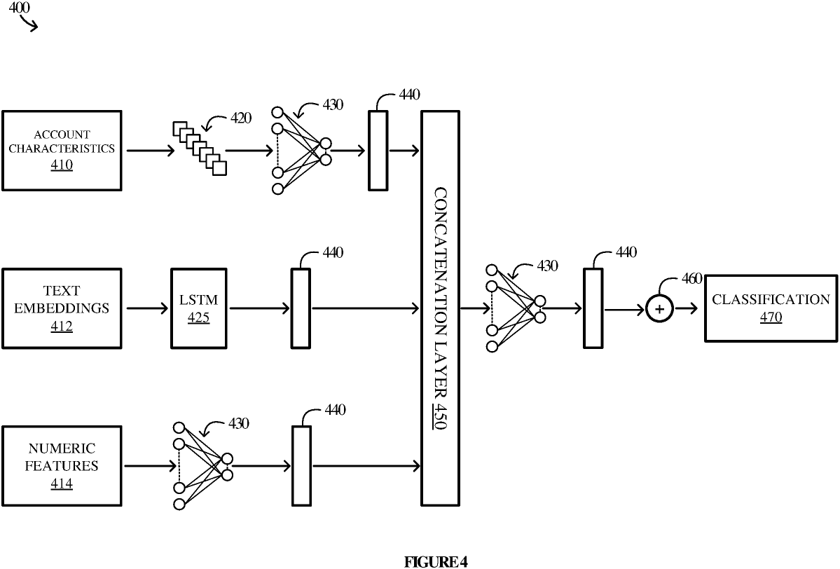

FIG. 4 illustrates an exemplary operating environment in which a data classifier can be utilized in an implementation. Figure includes environment 400, which further includes account characteristics 410, text embeddings 412, numeric features 414, convolution layer 420, long short-term memory (LTSM) layer 425, dense layer 430, activation layer 440, concatenation layer 450, summation layer 460, and classification 470. For example, environment 400 can be embodied in classification system 101 of FIG. 1, and it can operate using process 200 of FIG. 2.

Environment 400 embodies a multimodal neural network that integrates disparate user account data to make a prediction output through a single loss function. Specifically, the model can serve to classify accounts and messages associated with an event to determine whether the messages/accounts have information that can help authorities in emergency or high-stress situations, such as natural disasters or other crises.

In operation, a keyword query is performed to gather a data set of accounts and messages related to the keyword. In the data set, each of account characteristics 410, text embeddings 412, and numeric feature 414 refer to account or message related data that can be individually input into different neural network modalities. Account characteristics 410 includes user profile information, which can further include an account image, biography, average activity time or duration, and the like. Text embeddings 412 can include content related information, such as specific words in the message, addressees, embedded links or hyperlinks, and more. Numeric features 414 can refer to a number of messages associated with the account, number of original messages, percentage of redistributed messages, length of the message, and time of the message.

First, account characteristics 410 are input into convolution layer 420 (i.e., convolution neural network). The convolution layer 420 can be employed to analyze visual characteristics of the account, such as a profile picture associated with a user account. Further visual processing can be performed on images included within a message or microblog related to the keyword event or images not associated with the keyword. Account characteristics 410 can further be analyzed in a dense layer 430 such as a fully-connected layer and/or max-pooling layer to classify the images retrieved from one or more accounts in the data set. At activation layer 440, activation functions can be performed on account characteristics 410 such as rectified linear activation, logistics, or hyperbolic tangent functions. Account characteristics 410 allow the model to predict an account type and/or role based on images posted by the account on the social network. For example, an account with a profile picture including a dog is more probable to be associated with a personal account. Whereas a picture including a fire department logo and/or name can represent a first responder account.

Next, text embeddings 412 are input into LTSM layer 425 to recognize and analyze textual features of an account or message obtained in the keyword query. LTSM layer 425 can analyze individual messages from various accounts, multiple messages from one or more accounts, or some other combination as it helps the model identify feature vectors over a period of time captured in the data set. For example, the model can recognize character and word vector sequences of each message or content of the message from the social network. Text embeddings 412 are analyzed in activation layer 440 as well.

Numeric features 414 are first input to dense layer 430 specifically trained to identify numeric sequences and binary unigrams. The model can recognize patterns based on numeric features 414, such as percentage of redistribution of messages, to understand whether the account primarily provides first-hand knowledge in messages or passes information along to other accounts in a social network. For example, a news/media outlet likely produces original content in messages to demonstrate the source of the information. On the other hand, a user who frequently redistributes the news outlet’s information, can be recognized as a separate source and classification.

At concatenation layer 450, feature embeddings and vectors from each neural network layer are combined. Concatenation layer 450 adds each vector via learnable weights in preparation for classifying the account and message inputs. Then, the concatenated vector is input to a further dense layer 430, activation layer 440, and summation layer 460 to identify any patterns in the input data before finalizing a prediction.

Classification 470 is output from the model that denotes a category of an account and/or message related to the keyword. Classification 470 of an account can comprise an account type and an account role. An account type can be an organization, an individual, and/or feedbased (i.e., a bot). An account role can be an emergency organization/personnel, public sector, media, redistribution, and/or personalized, among others. In an embodiment, a user inputs messages and account information into the model to filter data provided by emergency organizations and media outlets. In other embodiments, a user can filter for other variations of account classifications. Messages can also be categorized and output from the model. Message classifications include reactionary/support, information sharing, information seeking, community response or outreach, official or otherwise firsthand/known sources, and more. Advantageously, a user can filter through thousands of messages that at least mention the keyword to find information that can help first responders or other organizations to combat a crisis.

It may be appreciated by one skilled in the art that filtering the output can occur in various ways, including using multiple layers, mass filtering, and filtering using only chosen subsets. In an example, a primary filter can first filter a data set by an account type and/or message type to look for firsthand, individualized information. Another filter can subsequently be applied to filter the data set by information containing sources in the content of the message to find official information.

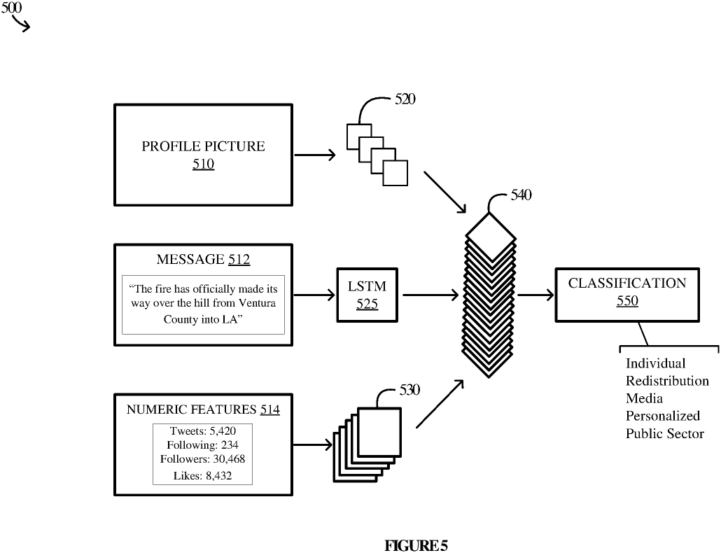

FIG. 5 illustrates an exemplary operating environment in which a data classifier can be utilized in an implementation. FIG. 5 includes operating environment 500, which further includes model inputs profile picture 510, message 512, and numeric features 514; neural network layers in convolution layer 520, long short-term memory (LTSM) layer 525, dense layer 530, concatenation layer 540, and an output denoting an account/message classifier in classification 550. For example, environment 500 can be embodied in classification system 101 of FIG. 1, and it can operate using process 200 of FIG. 2. Environment 500 can exemplify specific inputs into a machine learning model, such as one illustrated in environment 400 of FIG. 4.

In this example, the classifier ingests a profile picture 510 associated with an account, a user’s recent history (i.e., most recent 200 tweets) and a message 512 related to an event, profile information, and numeric features 514 and behavioral statistics, which include calculations such as the average number of tweets per day, percentage of tweets that are retweets, and the regularity of timing between tweets. The classifier combines multiple forms of neural networks: convolutional layer 520 for image data, bi-directional LSTM layer 525 for language processing, and feed-forward layer 530 for numeric values. These neural network outputs are then combined via learnable weights in concatenation layer 540 to make predictions about account classifications. As illustrated in environment 500, profile picture 510 and other image data is fed through a convolutional neural network, while in parallel, the text from the user’s tweet that reads “The fire has officially made its way over the hill from Ventura County into LA,” flows through the LSTM layer 525. Numeric features 514, including number of tweets, number of accounts following, number of followers, and number of tweets liked associated with the user’s account, are input to the feed-forward layer 530. While different methods and layers to analyze the data may be used, a classification 550 output results to predict the account role, account type, and content/message category.

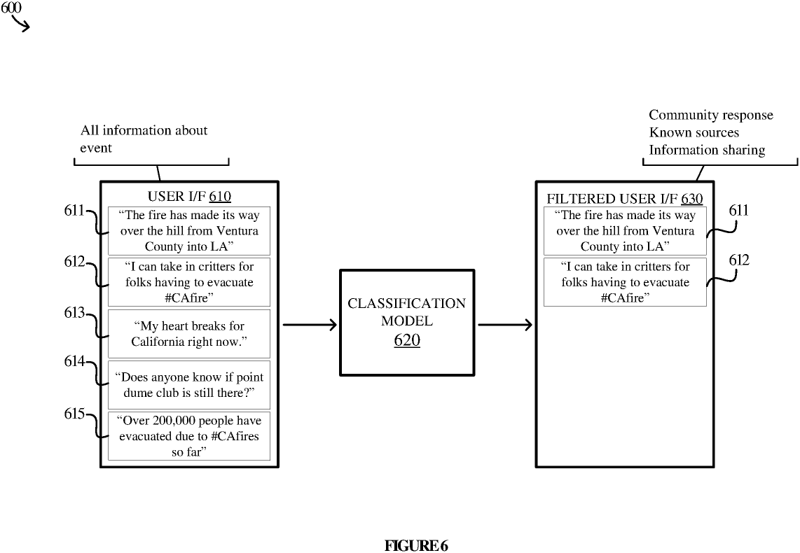

FIG. 6 illustrates an example of delivering classification results to an end-user in an implementation. FIG. 6 includes environment 600 which further includes user interface 610, classification model 620, and filtered user interface 630. User interface 610 further includes messages 611-615, which can be messages about an event. Filtered user interface 630 includes only messages 611 and 612 after the data has been filtered and classified through classification model 620. Classification model 620 can represent classification system 101 of FIG. 1 or the classification network of environment 400 of FIG. 4. Additionally, classification model 620 can implement process 200 of FIG. 2 and be trained using process 300 of FIG. 3.

User interface 610 displays several messages 611-615 pertaining to an event (i.e., a wildfire) on a social network. In various implementations, user interface 610 can be part of a phone, tablet, computer, or other device that operates a news or social media feed. Message 611 shows information sharing content to inform others of the location of a wildfire. Message 612 illustrates a community outreach message. Message 613 demonstrates a reactionary or support message that otherwise does not provide information about the catastrophe. Message 614 illustrates an information seeking message wherein a user is looking for information, but not necessarily providing any information. Message 615 is a general comment about the event. In some cases, message 615 can also be a media-sourced message, depending on whether the information came from a media outlet or an individual person.

Each of message 611-615, along with other account information and numeric features about the messages and accounts, are fed into classification model 620 to obtain filtered, predictive results. In various instances, a user or computing device seeking model predictions can use classification model 620 to filter for information with known sources, helpful tips or updates about the event, or otherwise helpful details that an emergency response team may require to perform search and rescue, for example. In other instances, different filters, filter layers, or classifications can be chosen. Classification model 620 can include one or more neural networks and layers in order to identify features of the message including an account identity and content of the message, generate feature embeddings for the message based on at least the account identity and content of the message, and obtain one or more classifications for the feature embeddings. As a result, classification model 620 outputs message 611 and 612 on filtered user interface 630 after determining those messages to be relevant or priority messages based on the content and account identity. It may be appreciated that user interface 610 and filtered user interface 630 can be the same user device or they may be different devices.

Additionally, it may be appreciated that one or more messages identified can comprise embedded links or hyperlinks included in its content, which identifies a particular source. Embedded links, and the content located at the link source itself in particular, may be analyzed as part of the content used to generate feature embeddings before classification and filtering.

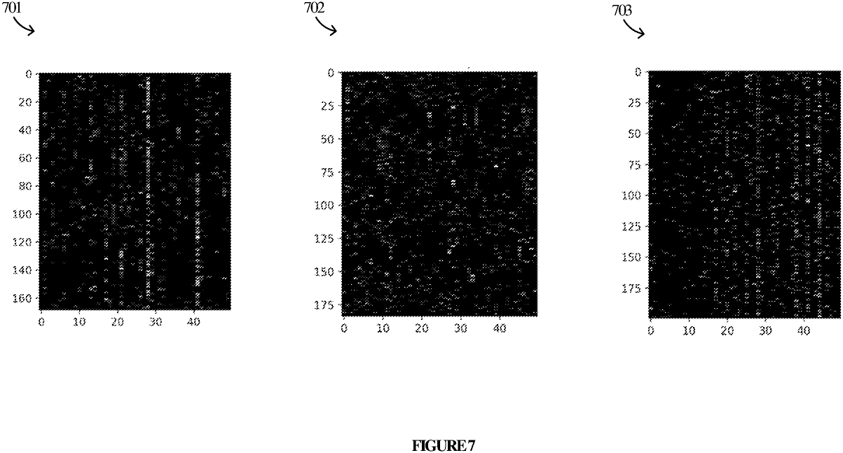

Moving to FIG. 7, FIG. 7 illustrates exemplary model results following data classification in an implementation. FIG. 7 includes three example aspects demonstrating a frequency and number of important/relevant messages per account based on a classification. As illustrated, aspect 701 depicts an emergency responder account, aspect 702 shows a personal account, and aspect 703 portrays a news/media account.

Each aspect in FIG. 7 charts a topic index (i.e., a subject of a microblog) versus a message index (i.e., number of messages). An emergency management user can be expected to consistently discuss few topics with high confidence. Personal/individual users can be expected to discuss a variety of topics at sporadic times. Media users can be expected to have a structured diversity of topics to cover several news stories at different times. Each of aspects 701-703 map these expectations, wherein a higher brightness pixel value indicates a greater topic confidence for that message.

Data from each of aspect 701-703 can be obtained using learned latent Dirichlet allocation (LDA) topics as input features. The data may be used as input to a convolutional neural network. In an implementation, an LDA model can be trained to use microblog text to discover 50 topics over 50 epochs, wherein each microblog from each user may be considered an independent document. Once the model learns to convert binary unigrams into topic score vectors (where each index is a topic and each value is the confidence of that topic), all microblogs from a user can be scored. Then, scores can be averaged across microblogs to generate a mean topic score vector of length 50 – a topic centrality measure. This average topic score vector can be sparsified by retaining the top-10 values and setting the rest to zero to improve the computational efficiency of near-zero values. A measure of topic variability for each user can be determined. For each user, topic score vectors from a number of microblogs can be used to produce data as illustrated in each of aspects 701-703.

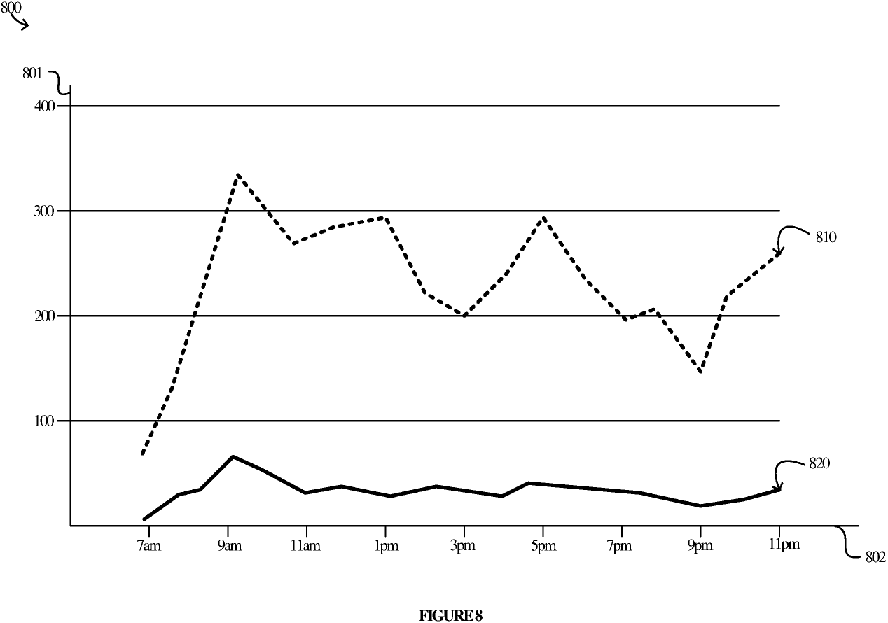

FIG. 8 illustrates exemplary model results following data classification in an implementation. Figure includes model results graph 800, which further includes amount axis 801, timeframe axis 802, and results plotted on graph 800 indicating an unfiltered amount 810 and a filtered amount 820, which accounts for a relevantly classified number of messages based on the unfiltered amount 810.

FIG. 8 may represent data collected during an event in an attempt to filter, for viewing, relevant, knowledgeable and/or important messages posted on a social network. As the event occurs, microblog data pertaining to a keyword search for the event can be downloaded. As shown by unfiltered amount 810, hundreds of microblogs with at least some content regarding the event can be found throughout the course of the event. However, some or most of the microblogs can be categorized as low priority, secondhand information, reactionary/supportive, and the like, wherein such categories do not provide valuable information to emergency responders. Using a multimodal classification model, each message of unfiltered amount 810 can be analyzed for content of the message and/or account identity, among other things, to filter out the aforementioned categories from view, thus, leaving a system or user with a filtered amount 820 of microblogs.

This paragraph includes an anecdotal example regarding FIG. 8 and tweets from the social network Twitter about a wildfire event: During the fire as new tweets were downloaded, the most frequently occurring accounts and sources for online content embedded in the tweets were manually labeled based on their role in the disaster (e.g., media, emergency response, individual-local). The labeled dataset was later used to implement a filter, removing content from accounts unlikely to contain new information. The sources include mainstream media, official emergency response, and other organizations involved in the response. Any tweet that comes from one of these known sources or has content from one of these sources is unlikely to contain new information that the emergency response team did not already know. After excluding tweets from emergency response, mainstream media, news aggregators, official public sector organizations, and known spam accounts, as well as any tweets with links to content from these sources, the dataset was re-examined. First, the filter reduced the overall volume of tweets by over 80%. When social media traffic was at its peak, there were a total of 4,033 tweets with a filtered dataset of 755 tweets. The peak occurred between 9 and 10 am, reducing the volume from 349 tweets to just 68 tweets. Second, once the noise was removed, local content was easily identified and a much clearer picture of what was happening at the community level emerged.

Another anecdotal example is provided herein. In a recent study using a data classifier in accordance with various embodiments, 126,041 tweets related to public response to the lockdown orders in Colorado from March 30^{th} to April 15^{th} 2020 were identified. After classifying the data set as individual-personalized or organization-personalized, the data classifier reduced the total number of tweets to 7,335 tweets. Next, a secondary filter was applied to remove tweets containing primarily auto-generated media or newsfeed content, which allowed the data classifier to refine the data set to 4,163 tweets containing community-level information. Emergency response authorities can then use this subset of tweets to identify personal reflections, impacts from the pandemic, collective responses to stay-at-home orders, and links to official websites offering lockdown information and orders.

FIG. 9 illustrates computing system 901 that is representative of any system or collection of systems in which the various components, modules, processes, programs, and scenarios disclosed herein may be implemented. Examples of computing system 901 include, but are not limited to, server computers, cloud computing platforms, and data center equipment, as well as any other type of physical or virtual server machine, container, and any variation or combination thereof. Other examples include desktop computers, laptop computers, tablet computers, Internet of Things (IoT) devices, wearable devices, and any other physical or virtual combination or variation thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements data classification process 906, which is representative of the multimodal machine learning processes and classification of message and account data discussed with respect to the preceding Figures. Software 905 also includes and implements model training process 916, which is representative of the machine learning model training processes discussed with respect to the preceding Figures. When executed by processing system 902 to provide enhanced similarity search, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including data classification process 906 and model training process 916) may be implemented in program instructions and among other functions may, when executed by processing system 902, direct computing system 901 to operate as described with respect to the various operational scenarios, sequences, and processes illustrated herein. For example, software 905 may include program instructions for implementing enhanced similarity search as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to provide enhanced similarity search. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a data classification model, comprising:
identifying messages on a social network associated with an event;
for each message of the messages:
identifying features of the message including an account identity and content of the message;
generating a feature embedding for the message based at least on the account identity and the content of the message; and
submitting the feature embedding as input to a machine learning model to obtain one or more classifications for the message; and
filtering the messages based on the one or more classifications.

2. The method of claim 1, further comprising identifying numerical features of each message of the messages, wherein the numerical features include one or more account statistics and one or more message statistics.

3. The method of claim 1, wherein the machine learning model comprises a multimodal network including at least one among a long short-term memory layer, a convolution neural network layer, and a fully-connected layer.

4. The method of claim 1, wherein the one or more classifications comprise at least one among a message type, an account type, and an account role.

5. The method of claim 1, wherein filtering the messages based on the one or more classifications comprises sorting each message of the messages by two or more priority levels.

6. The method of claim 1, wherein the account identity comprises at least one among an account name, an account image, and an account description.

7. The method of claim 1, wherein the content of the message comprises one or more words in the message associated with the event.

8. A computing apparatus comprising:
one or more computer readable storage media; and
program instructions stored on the one or more computer readable storage media that, when read and executed by one or more processors, direct the computing apparatus to at least:
identify messages on a social network associated with an event;
for each message of the messages:
identify features of the message including an account identity and content of the message;
generate a feature embedding for the message based at least on the account identity and the content of the message; and
submit the feature embedding as input to a machine learning model to obtain one or more classifications for the message; and
filter the messages based on the one or more classifications.

9. The computing apparatus of claim 8 further comprising the one or more processors, wherein the programming instructions further direct the computing apparatus to identify numerical features of each message of the messages, wherein the numerical features include one or more account statistics and one or more message statistics.

10. The computing apparatus of claim 8, wherein the machine learning model comprises a multimodal network including at least one among a long short-term memory layer, a convolution neural network layer, and a fully-connected layer.

11. The computing apparatus of claim 8, wherein the one or more classifications comprise at least one among a message type, an account type, and an account role.

12. The computing apparatus of claim 8, wherein to filter the messages based on the one or more classifications, the program instructions instruct the computing apparatus to sort each message of the messages by two or more priority levels.

13. The computing apparatus of claim 8, wherein the account identity comprises at least one among an account name, an account image, and an account description.

14. The computing apparatus of claim 8, wherein the content of the message comprises one or more words in the message associated with the event.

15. A method of training a machine learning model, comprising:
creating a data set to train a machine learning model, wherein the data set comprises messages and accounts on a social network associated with an event;
generating one or more feature embeddings for each message of the messages and each account of the accounts;
submitting the one or more feature embeddings as input to the machine learning model to obtain one or more classifications for the data set; and
validating the one or more classifications.
